(19) United States
(12) Patent Application Publication
(10) Pub. No.: US 2004/0095379 A1
(43) Pub. Date: May 20, 2004

(54) Method of creating background music for slideshow-type presentation

(76) Inventors: Chirico Chang, Taipei (TW); Shawn Chiu, Taipei (TW); Jia-Sheng Su, Kaohsiung (TW); Jeff Dai, Kaohsiung (TW); Victor Lin, Kaohsiung (TW)

Correspondence Address: BIRCH STEWART KOLASCH & BIRCH, PO BOX 747, FALLS CHURCH, VA, 22040-0747, US

(21) Appl. No.: 10/294,810

(22) Filed: Nov. 15, 2002

(51) Int. Cl. G09G 5/00

(52) U.S. Cl. 345/727; 345/732

(57) ABSTRACT

A method of creating background music for slideshow-type presentation. The method includes the steps of displaying in a slide arrangement area a plurality of slide representations, each of which indicates a slide in the slideshow, associating a selected slide with an audio file for both to initialize simultaneously during the slideshow, displaying in a audio arrangement area separated from the slide arrangement area an audio representation indicating the audio file, aligned with the slide representation indicating the selected slide.

### BACKGROUND OF THE INVENTION

1. Field of the Invention

The present invention relates to a authoring method for a slideshow-type presentation and particularly to a method of creating background music for slideshow-type presentation

2. Description of the Prior Art

Technologies are known in which image information and music tone information are reproduced in synchronization with each other. One of these technologies is a software program by which a user-generated digital photo album or video collection is edited based on photographs or video clips. This software allows the user to combine images or video clips and reproduce the combined results in a presentational manner. This software also allows the user to attach desired background music to one or more desired photographs or video clips. Further, this software allows the user to add visual effects such as wipe, fade-in, and fade-out when changing pages or video clips, thereby imparting screen effects such as page turning or video clip transition.

In order to create a multimedia presentation in a presentational manner with an accompanying soundtrack for background music, an author creates or locates appropriate audio files to embed in the presentation, and then associates an individual audio file with each slide or video clip, in an appropriate and aesthetically pleasing sequence.

One example of a popular slide presentation program is Microsoft PowerPoint, available from Microsoft Corporation, of Redmond, Wash. An audio file containing audio data can be optionally associated with each slide of a slide presentation. However, the Graphical User Interface (GUI) of Microsoft PowerPoint for association of the slides and audio files is limited in usability.

There are some slide show presentation programs providing a more friendly GUI with a timeline as shown in FIG. 1. The GUI comprises a main window 1, a preview area 12, a file list area 13, a timeline 14, a slide arrangement area 15 and an audio arrangement area 16. The author may add such as drag and drop slides or video clips from the file list area 13 into the slide arrangement area 15 to form a slide sequence by reference to the timeline 14. The author may also add such as drag and drop audio files from the file list area 13 into the audio arrangement area 16 to form an audio sequence by reference to the timeline 14. Thus, by using the timeline, the author can easily associate the audio files with the slides.

However, general slide-show authors use slide as the reference to synchronize the audio, not the absolute time point. They usually first complete a slide sequence with reference to time and then arrange the audio files by reference to the slide sequence. It is not convenient for users only to use the timeline as a reference when making the audio sequence since they must remember the time each slide starts or stops. When slideshow change the time, the audio synchronization needs to reset.

### SUMMARY OF THE INVENTION

The object of the present invention is to provide an authoring method for a slideshow-type presentation having a friendly GUI without using a timeline.

The present invention provides a method of creating background music for slideshow-type presentation. The method comprises the steps of displaying in a first area a plurality of first representations, each of which indicates initialization of slide in a slideshow, associating a selected slide with an audio file for both to initialize simultaneously during the slideshow, displaying in a second area separated from the first area a second representation indicating initialization of the audio file, aligned with the first representation indicating initialization of the selected slide.

The present invention further provides a method of creating background music for slideshow-type presentation. The method comprises the steps of displaying in a first area a plurality of first representations for slides in a slideshow-type presentation and a second representation for an audio file, allowing the first representations in the first area to be added such as dragged and dropped into a second area, determining a sequence of the slides according to the order of positions where the first representations are dropped in the second area, displaying in the second area by the sequence a plurality of third representations, each of which indicates initialization of slide, allowing the second representation in the first area to be added such as dragged and dropped into a third area, determining the slide corresponding to a position where the second representation is dropped in the third area as a selected slide, displaying in the third area a fourth representation indicating initialization of the audio file, aligned with the third representation indicating initialization of the selected slide, and associating the selected slide with the audio file for both to initialize simultaneously during the slideshow.

Thus, by reference to slides instead of time, users can easily synchronize the slides and audio clips when they add background music to a slideshow.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing a conventional GUI for slideshow authoring.

FIGS. 2A˜2D, 3A˜3C, 4 and 5 are diagrams showing a GUI used to add background music to a slideshow-type presentation according to one embodiment of the invention.

FIG. 6 is a flowchart of a method of creating background music for slideshow-type presentation according to one embodiment of the invention.

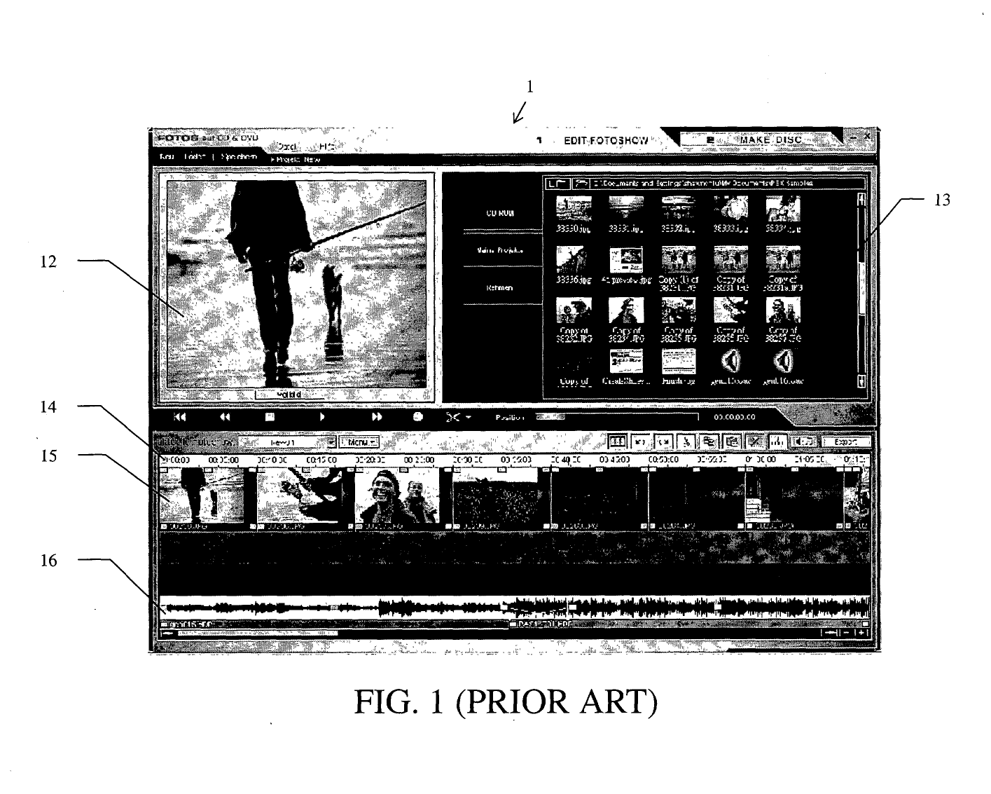

### DETAILED DESCRIPTION OF THE INVENTION

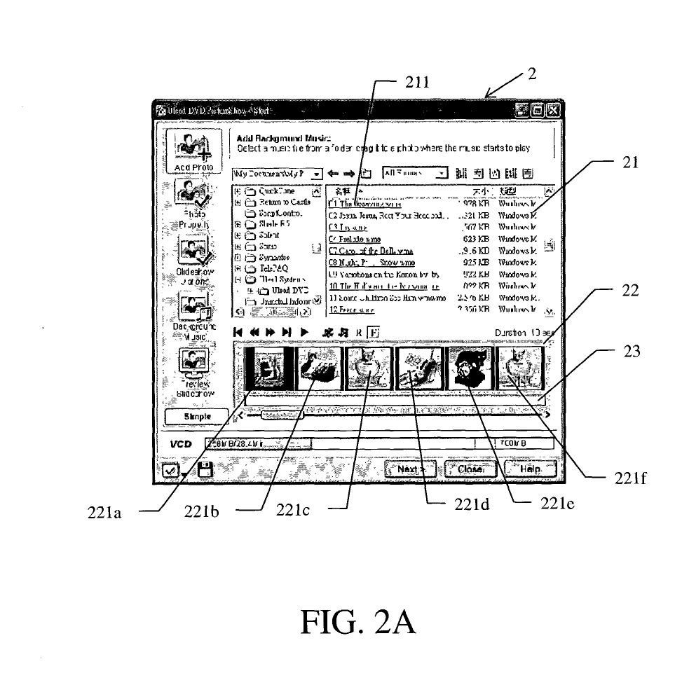

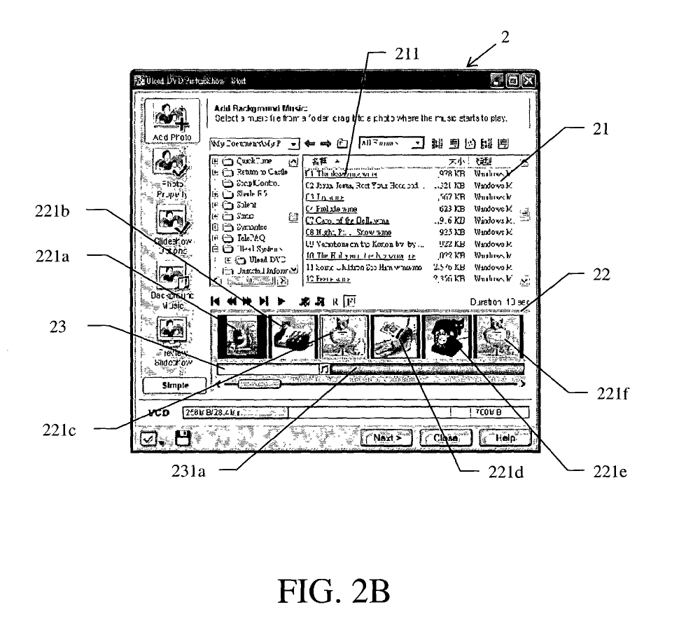

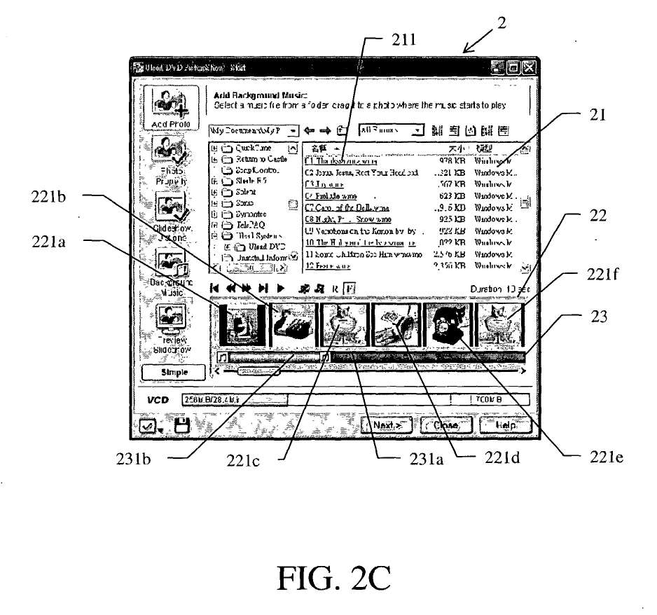

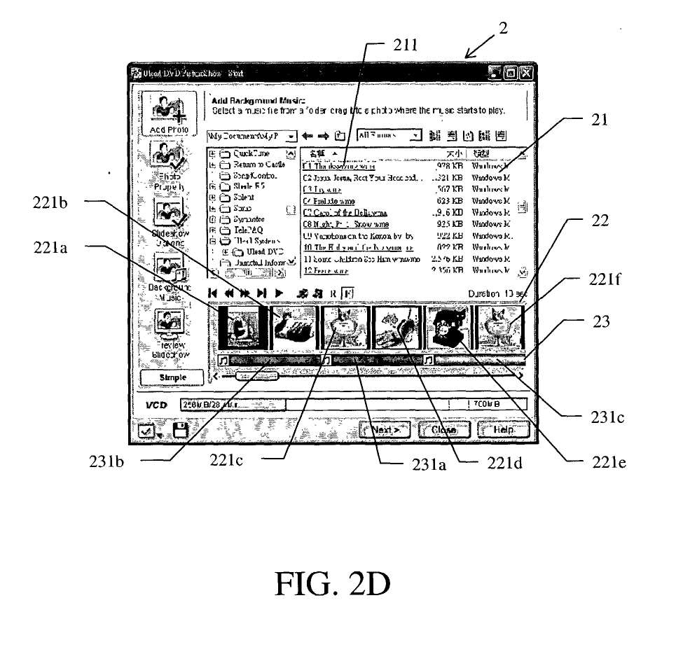

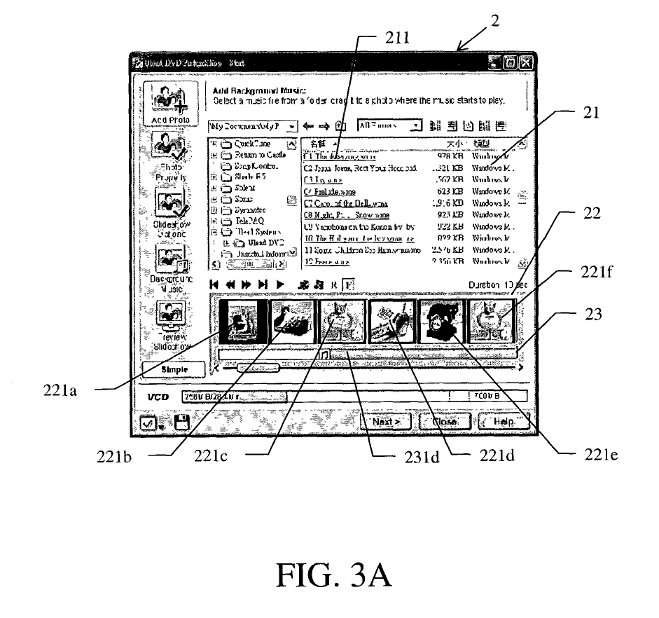

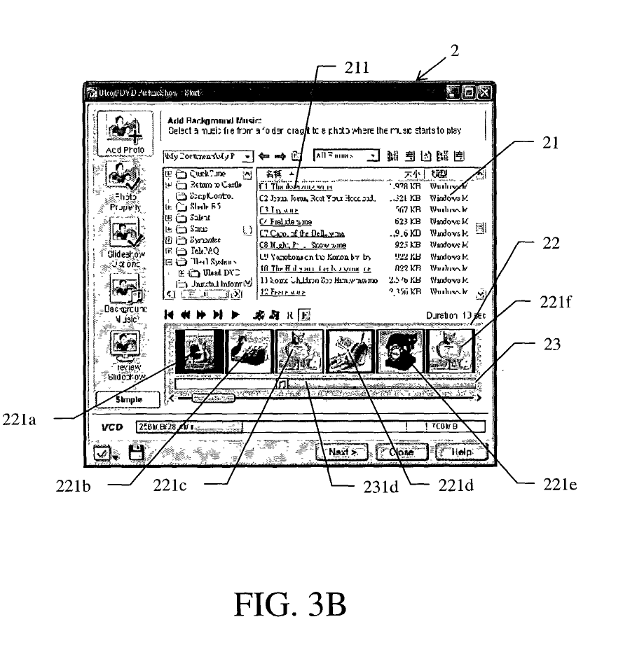

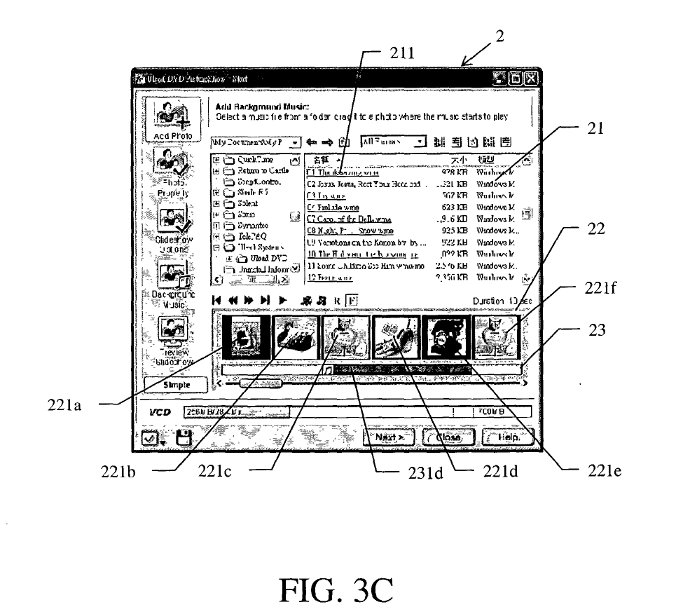

FIG. 2A is a diagram showing a GUI used to add background music to a slideshow-type presentation according to one embodiment of the invention. The GUI comprises a main window 2, an file list area 21, slide arrangement area 22 and audio arrangement area 23. The audio files and slides (images or video clips) are represented by their file names 211 in the file list area 21. The GUI allows users to add such as drag and drop the slides and audio files represented as their file names 211 in the file list area 21 into the slide and audio arrangement area 22 and 23 respectively. Thus, the users may determine sequences of the slides and audio files by order of positions where the slides and audio files are dropped in the slide and audio arrangement area 22 and 23. The slides dropped in the slide arrangement area 22 are represented by thumbnails 221a˜221f arranged by the slide sequence recognized by the users. Each of the thumbnails 221a˜221f indicates initialization and termination of the corresponding slide by the left and right side of the thumbnail respectively.

There are four modes of synchronization, Auto Repeat 1, Auto Repeat 2, No Repeat and Break Off.

FIGS. 2A˜2D are diagrams showing the operation of adding background music in Auto Repeat 1 synchronization mode.

In FIG. 2A, as previously described, a slide sequence is recognized by a user adding such as dragging and dropping slides into the slide arrangement area 22 and represented by the ordered thumbnails 221a˜221f.

In FIG. 2B, an audio file represented by filename 211 in the file list area 21 is added such as dragged and dropped into the audio arrangement area 23. The slide 221c, for example, corresponding to a position where the audio file is dropped in the audio arrangement area 23, is recognized as an associated slide. The audio file dropped into the audio arrangement area 23, is represented by a bar 231a indicating initialization and termination of the audio file, aligned with the left side of the thumbnail 221c of the associated slide and the end of the slide sequence. The audio file will initialize simultaneously with the associated slide during the slideshow and will be played repeatedly until the end of the slideshow.

In FIG. 2C, another audio file represented by filename 211 in the file list area 21 is added such as dragged and dropped into the audio arrangement area 23. The slide 221a, for example, corresponding to a position where the audio file is dropped in the audio arrangement area 23, is recognized as an associated slide. The audio file dropped into the audio arrangement area 23, is represented by a bar 231b indicating initialization and termination of the audio file, aligned with the left side of the thumbnail 221a of the associated slide and the right side of the thumbnail 221b. The audio file will initialize simultaneously with the associated slide 221a during the slideshow and will be played repeatedly until the end of the slide 221b.

In FIG. 2D, another audio file represented by filename 211 in the file list area 21 is again added such as dragged and dropped into the audio arrangement area 23. The slide 221e, for example, corresponding to a position where the audio file is dropped in the audio arrangement area 23, is recognized as an associated slide. The audio file dropped into the audio arrangement area 23, is represented by a bar 231c indicating initialization and termination of the audio file, aligned with the left side of the thumbnail 221e of the associated slide and the end of the slide sequence. The audio file will initialize simultaneously with the associated slide 221e during the slideshow and will be played repeatedly until the end of the slideshow.

It is noted that, in Auto Repeat 1 mode, the added audio files will initialize simultaneously with the associated slides recognized by the positions where the audio files are dropped in the audio arrangement area 23, and will be played repeatedly until the next audio file initializes or the end of the slideshow.

FIGS. 3A˜3C are diagrams showing the operation of adding background music in Auto Repeat 2 synchronization mode.

In FIG. 3A, as previously described, a slide sequence is recognized by a user adding such as dragging and dropping slides into the slide arrangement area 22 and represented by the ordered thumbnails 221a˜221f. An audio file represented by filename 211 in the file list area 21 is added such as dragged and dropped into the audio arrangement area 23. The slide 221c, for example, corresponding to a position where the audio file is dropped in the audio arrangement area 23, is recognized as an associated slide. The audio file dropped into the audio arrangement area 23, is represented by a bar 231d indicating initialization and termination of the audio file, aligned with the left side of the thumbnail 221c of the associated slide and the end of the slide sequence. The audio file will initialize simultaneously with the associated slide during the slideshow and will be played repeatedly until the end of the slideshow.

In FIG. 3B, slide is selected by the user clicking the thumbnail 221e, for example.

In FIG. 3C, by selecting the thumbnail 221e, the end of the bar 231d is cut back to align with the right side of the thumbnail 221e of the selected slide. The audio file will initialize simultaneously with the associated slide 221c and will be played repeatedly until the end of the slide 221e.

It is noted that, in Auto Repeat 2 mode, the added audio file will initialize simultaneously with the associated slides recognized by the positions where the audio files are dropped in the audio arrangement area 23, and will be played repeatedly until the end of the slide selected by the user.

It is also noted that, in Auto Repeat 2 mode, it is possible that the bar 231 may overlaps an existing bar (not shown) added earlier. In such a case, a modification can be made, such as cutting off the overlapping portion of the existing bar so the audio file for the existing bar will be terminated as previously set, or shifting the existing bar afterwards so the audio file for the existing bar will start only after the audio file 211 for the bar 231 is terminated.

FIG. 4 is a diagram showing the operation of adding background music in No Repeat synchronization mode.

In FIG. 4, an audio file represented by filename 211 in the file list area 21 is added such as dragged and dropped into the audio arrangement area 23. The slide 221c, for example, corresponding to a position where the audio file is dropped in the audio arrangement area 23, is recognized as an associated slide. The audio file dropped into the audio arrangement area 23, is represented by a bar 231e indicating initialization and termination of the audio file, aligned with the left side of the thumbnail 221c of the associated slide but ends between the left and right side of the thumbnail 221d. The audio file will initialize simultaneously with the associated slide during the slideshow and will be played only once. The length of the bar 231e shows exactly the percentage of the playback time of the slide.

FIG. 5 is a diagram showing the operation of adding background music in Break Off synchronization mode.

In FIG. 5, an audio file represented by filename 211 in the file list area 21 is added such as dragged and dropped into the audio arrangement area 23. The slide 221b, for example, corresponding to a position where the audio file is dropped in the audio arrangement area 23, is recognized as an associated slide. The audio file dropped into the audio arrangement area 23, is represented by a bar 231g indicating initialization and termination of the audio file, aligned with the left side of the thumbnail 221b of the associated slide and the right side of the thumbnail 221d. This can be achieved by Auto Repeat 1 or 2 mode. Additionally, slide is selected by the user clicking the thumbnail 221c for example. By selecting the slide, a silence icon 231h breaks into the bar 231g and is aligned with the thumbnail 221c of the selected slide. The silence icon 231h indicates pausing of the added audio file represented by the bar 231g when the selected slide is being played during the slideshow.

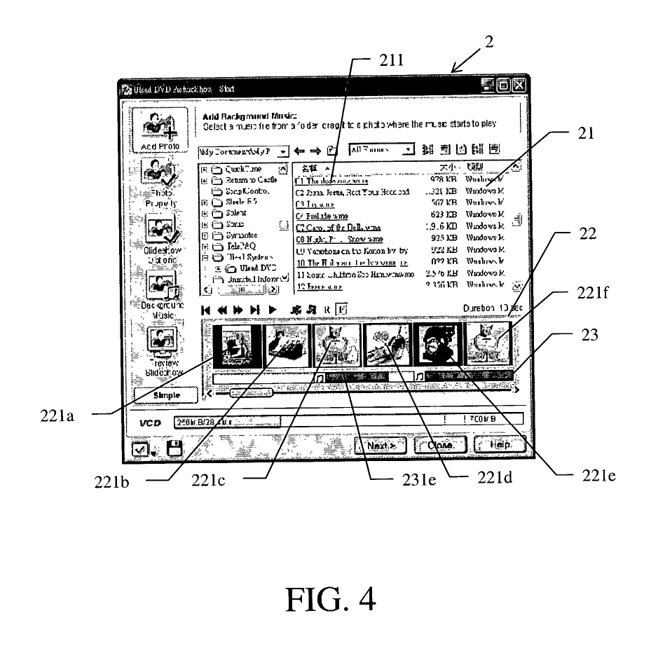

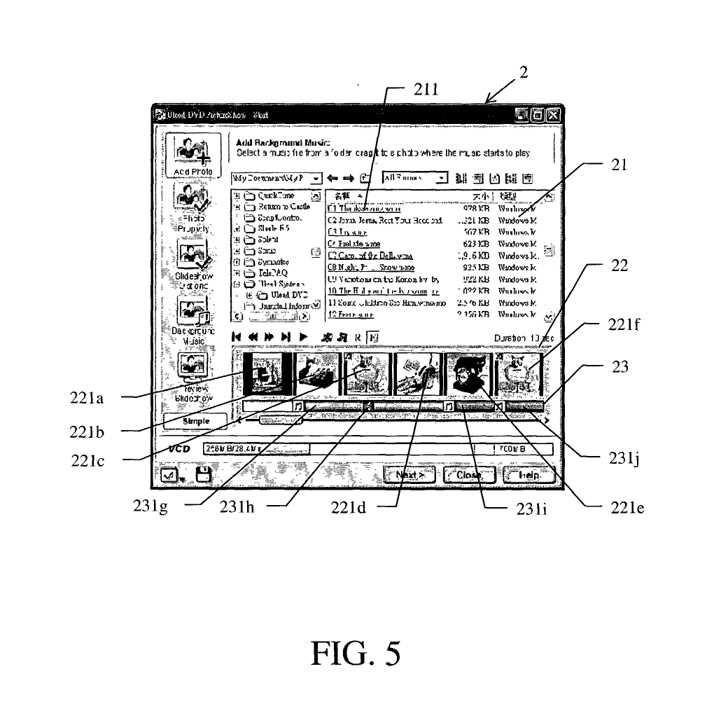

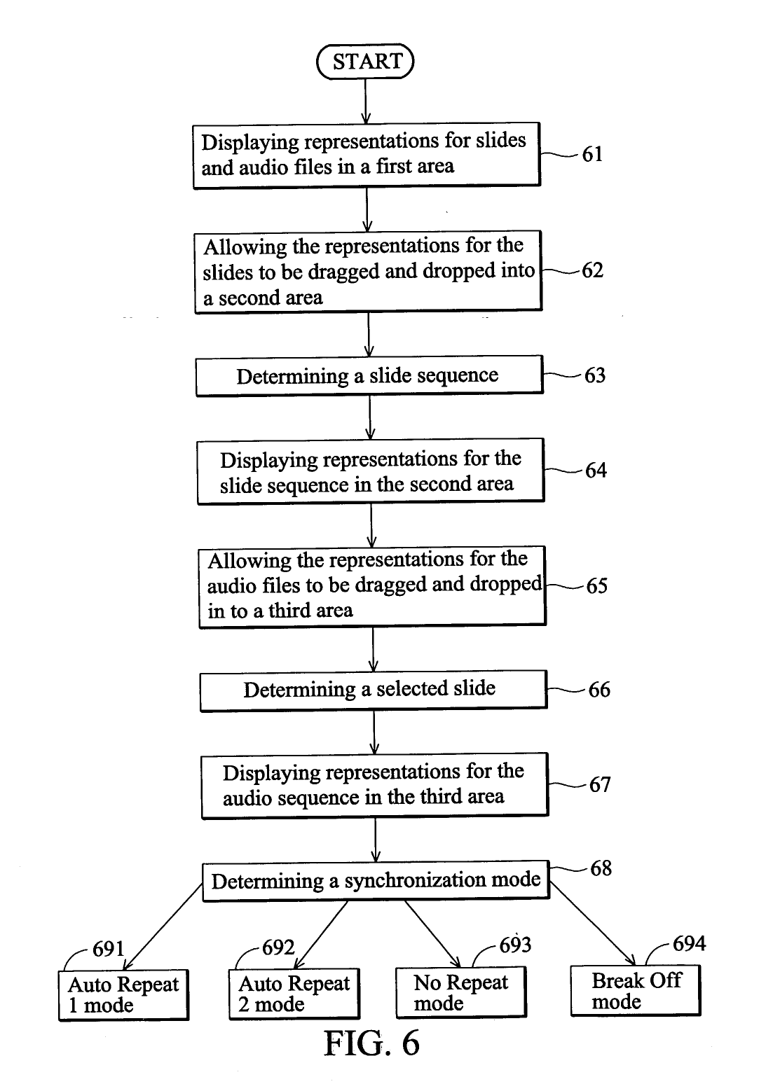

FIG. 6 is a flowchart of a method of creating background music for slideshow-type presentation according to one embodiment of the invention.

In step 61, first representations for slides in a slideshow-type presentation and a second representation for an audio file are displayed in a first area. The first and second representations may be filenames. The slides may be images or video clips.

In step 62, the first representations in the first area can be added such as dragged and dropped into a second area.

In step 63, a sequence of the slides according to the order of positions where the first representations are dropped in the second area is recognized

In step 64, third representations, each of which indicates initialization and termination of slide, are displayed by the sequence of the slides in the second area. The third representations may be thumbnails with left and right sides indicating initialization and termination of the slides respectively.

In step 65, the second representation in the first area can be added such as dragged and dropped into a third area.

In step 66, the slide corresponding to a position where the second representation is dropped in the third area is recognized as a selected slide.

In step 67, a fourth representation is displayed in the third area indicating initialization and termination of the audio file, aligned with the third representation indicating initialization and termination of the selected slide. The fourth representation may be a bar with a beginning and end edge indicating initialization and termination of the audio file.

In step 68, a synchronization mode is recognized by a user.

In step 691, if Auto Repeat 1 mode is used, the audio files will initialize simultaneously with the associated slides and will be played repeatedly until the next audio file initializes or the end of the slideshow.

In step 692, if Auto Repeat 2 mode is used, another slide is selected by the user clicking one of the third representations in the second area, and the fourth representation displayed in the third area and indicating termination of the audio file is aligned with the third representation indicating termination of the slide selected by clicking. Then, the slides selected by clicking and in step 65 are associated with the audio file. The audio file will initialize simultaneously with the slide selected in step 65 and terminate simultaneously with the slide selected by clicking during the slideshow.

In step 693, if No Repeat mode is used, the selected slide is associated with the audio file for both to initialize simultaneously during the slideshow. The audio file will be played only once.

In step 694, if Break Off mode is used, another slide is selected by the user clicking one of the third representations in the second area. A fifth representation displayed in the third area and indicating pausing of the audio file is aligned with the first representation of the slide selected by clicking. The audio file is associated to the slide selected in step 65 for both to initialize simultaneously, and pause when the slide selected by clicking is being played during the slideshow.

In conclusion, the present invention provides a GUI that is intuitive enough for normal users to easily synchronize slides and background music. For normal users, this GUI is simpler than the conventional GUI with a timeline. Also, in another embodiment, the adding of audio files can be done for either a single audio file or a group of audio files. In the latter case, the group of audio files will be sequentially played and repeated for the designated slide(s).

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as recognized by the appended claims when interpreted in accordance with the breadth to which they are fairly, legally, and equitably entitled.

What is claimed is:

1. A method of creating background music for slideshow-type presentation comprising the steps of:
displaying in a first area a plurality of first representations, each of which indicates a slide in a slideshow;
associating a selected slide with an audio file for both to initialize simultaneously during the slideshow; and
displaying in a second area separated from the first area a second representation indicating the audio file, aligned with the first representation indicating the selected slide.

2. The method as claimed in claim 1, wherein the first representations in the first area is arranged by a sequence of the slides.

3. The method as claimed in claim 2 further comprising the step of:
displaying a plurality of third representations for the slides in a third area;
allowing the third representations in the third area to be added into the first area; and
determining the sequence of the slides according to the order of positions where the third representations are dropped in the first area.

4. The method as claimed in claim 1, wherein the slides comprise images and video clips.

5. The method as claimed in claim 1 further comprising the steps of:
displaying a fourth representation for the audio file in a third area;
allowing the fourth representation in the third area to be added into the second area; and
determining the slide corresponding to a position where the fourth representation is dropped in the second area as the selected slide.

6. The method as claimed in claim 1, wherein each of the first representations further indicates termination of slide, and the second representation further indicates termination of the audio file.

7. The method as claimed in claim 6 further comprising the steps of:
associating a second selected slide with the audio file for both to terminate simultaneously during the slideshow; and
displaying in the second area the second representation indicating termination of the audio file, aligned with the first representation indicating termination of the second selected slide.

8. The method as claimed in claim 6 further comprising the steps of:
determining a third selected slide for the audio file to pause when the third selected slide is played during the slideshow; and
displaying in the second area a fifth representation indicating pausing of the audio file, aligned with the first representation indicating initialization and termination of the third selected slide.

9. The method as claimed in claim 6, wherein the first representations are thumbnails of the slides with left and right sides indicating initialization and termination of the slides respectively.

10. The method as claimed in claim 6, wherein the second representation is a bar indicating initialization and termination of the audio file.

11. The method as claimed in claim 1 further comprising the steps of:
associating another selected slide to another audio file for both to initialize simultaneously during the slideshow, wherein one of the audio files is to be repeatedly played until initialization of the other audio file.

12. A method of creating background music for slideshow-type presentation comprising the steps of:
displaying in a first area a plurality of first representations for slides in a slideshow-type presentation and a second representation for an audio file;
allowing the first representations in the first area to be added into a second area;
determining a sequence of the slides according to the order of positions where the first representations are dropped in the second area;
displaying in the second area by the sequence a plurality of third representations, each of which indicates initialization of slide;
allowing the second representation in the first area to be added into a third area;
determining the slide corresponding to a position where the second representation is dropped in the third area as a selected slide;
displaying in the third area a fourth representation indicating initialization of the audio file, aligned with the third representation indicating initialization of the selected slide; and
associating the selected slide with the audio file for both to initialize simultaneously during the slideshow.

13. The method as claimed in claim 12, wherein the slides comprise images and video clips.

14. The method as claimed in claim 12, wherein each of the third representations further indicates termination of slide, and the fourth representation further indicates termination of the audio file.

15. The method as claimed in claim 14 further comprising the steps of:
selecting a second slide;
displaying in the third area the fourth representation indicating termination of the audio file, aligned with the third representation indicating termination of the selected second slide; and
associating the selected second slide with the audio file for both to terminate simultaneously during the slideshow.

16. The method as claimed in claim 14 further comprising the steps of:
selecting a third slide;
displaying in the third area a fifth representation indicating pausing of the audio file, aligned with the first representation indicating initialization and termination of the selected third slide; and
associating the audio file with the selected third slide to pause when the selected third slide is played during the slideshow.

17. The method as claimed in claim 14, wherein the third representations are thumbnails of the slides with left and right sides indicating initialization and termination of the slides respectively.

18. The method as claimed in claim 14, wherein the fourth representation is a bar indicating initialization and termination of the audio file.
